(19) United States
(12) Patent Application Publication
(10) Pub. No.: US 2022/0053417 A1
(43) Pub. Date: Feb. 17, 2022

(54) SELECTING A NETWORK ON THE BASIS OF REAL-TIME NETWORK CHARACTERISTICS

(71) Applicant: Orange, Paris (FR)

(72) Inventor: Bertrand Bouvet, CHÂTILLON CEDEX (FR)

(21) Appl. No.: 17/312,341

(22) PCT Filed: Dec. 9, 2019
(86) PCT No.: PCT/FR2019/052962

§ 371 Date: Jun. 9, 2021

(30) Foreign Application Priority Data
Dec. 10, 2018 (FR) 1872579

(51) Int. Cl. H04W 48/18; H04W 48/08; H04W 76/15

(52) U.S. Cl. CPC H04W 48/18; H04W 88/06; H04W 76/15; H04W 48/08

(57) ABSTRACT

Disclosed are a terminal able to be connected simultaneously to a plurality of access networks, a method for selecting an access network using the terminal, and a device and a method for providing characteristic information of an access network. The selection method, which can be implemented by a terminal, includes receiving an information packet from a device for providing characteristic information of an access network, the terminal being connected to this access network, and depending on the characteristic information obtained from the information packet, at least of maintaining a connection to at least one access network to which the terminal is already connected or connecting to at least one other different technology access network.

### PRIOR ART

The invention relates to the general field of telecommunications. It concerns more particularly the field of offloading the communications usually called “offload”.

A majority of the terminals currently available on the market can connect to access networks of different technologies, such as a WiFi access network, a wired access network (fiber optic, ADSL or Ethernet network) or a cellular access network (3G, 4G or 5G for example). Such terminals have a module for selecting the access network.

In addition, there are terminals that can be connected simultaneously to two access networks. This functionality is known as “access network aggregation”. Such terminals have an aggregation module.

FIG. 1 presents an architecture of a network of the prior art. A terminal TRM having an access network selection module and an aggregation module can alternately or simultaneously connect to two access networks LAN1 and LAN2. The terminal TRM connects to a core network CAN via at least one of the networks LAN1 and LAN2. The network CAN is connected to another network NET. Two servers SRV1 and SRV2 are connected to the network NET. The network NET can be the Internet network. In this example, the network CAN is a core network managed by the same operator as the access networks LAN1 and LAN 2.

In the example of FIG. 1, the aggregation module of the terminal TRM deploys the MPTCP (Multi Path Transport Control Protocol) protocol defined by the IETF (RFC6824 standard). Nowadays, the Apple terminals (registered trademark) use this MPTCP protocol. However, to aggregate the traffic between the terminal and a server SRV1 for example, it is necessary that this server SRV1 also supports this same MPTCP protocol.

When the terminal TRM wishes to communicate with a server, for example SRV2, which does not support the MPTCP protocol, the traffic emitted by the terminal TRM in aggregation on the access networks LAN1 and LAN2 is conveyed to an MCP (MPTCP Convergent Point) equipment which allows ensuring interworking between the MPTCP protocol and a standard TCP/UDP/SCTP protocol supported by the server SRV2. The MCP equipment is a node of the network CAN and it is also connected to the network NET.

The access network aggregation function allows particularly managing the traffic peaks and ensuring the transition of the traffic from one access network to another, the transition may be partial or complete.

There are other technical solutions allowing the selection and/or the aggregation of access networks such as the 3GPP release 13 solution of LWA (LTE WLAN Aggregation) type, the Google BandwidthX solution and the Passpoint solution defined by the WiFi Alliance standardization group (registered trademarks).

FIG. 2 illustrates a software architecture of a terminal T of the prior art, which can be connected simultaneously to several access networks. In this example, the terminal T has two access network interfaces HW1 and HW2. The interface HW1 is an electrical circuit (chipset) of WiFi technology, and the interface HW2 is an electrical circuit (chipset) of cellular radio technology, both circuits being accompanied by their driver software.

An operating system OS is installed above the interfaces HW1 and HW2. A module of a TCP/IP protocol stack is integrated into the operating system OS. The TCP/IP module integrates an ICMP (Internet Control Message Protocol) submodule. Above the TCP/IP module, an access selection module and an access aggregation module (in MPTCP for example) are also integrated without the operating system.

Above the operating system OS, one or more applications APP are installed. These applications rely on interfaces APIs provided by the operating system. Among these APIs, there is the TCP/IP API which allows an application APP to communicate on at least one of the access networks without knowing specifically which access interface HW1 or HW2 is used.

It is noted that an application APP can obtain, via the APIs, information on the state of connectivity with the access networks. In addition, the APIs other than the TCP/IP API can provide the “pull”, “push” or “notification” mode applications with the commonly used access network interface, HW1 and/or HW2. Thus, the application APP can adapt its services based on the access network. For example, a voice over IP (VoIP) application installed on a Smartphone-type terminal TRM can emit/receive communications only when the selected access network interface is HW1 of WiFi technology and not the cellular radio access interface HW2.

When the selection of an access network and the access aggregation function are not optimized, the quality of experience of the terminal user may deteriorate: selection of an access network that does not offer the best quality of service, or selection of a network whose connection cost does not correspond to user constraints and/or to parameters of a user account with the operator of the network.

There is therefore a need for a solution allowing the terminals that can be connected simultaneously to several access networks to optimize the access network selection, and also the access aggregation.

### DISCLOSURE OF THE INVENTION

The invention is aimed at a method for selecting at least one access network. The method is implemented by a terminal that can be connected to several access networks and comprises steps of:
receiving at least one packet called information packet, from a device for providing characteristic information of a said access network, the terminal being connected to this access network; and
based on the characteristic information obtained from the information packet, at least one step among:

maintaining a connection to at least one access network to which the terminal is already connected; and

connecting to at least another said access network of different technology, said characteristic information (infoA, infoB) of a said access network including at least information among:
information (infoB) on parameters of a user account of said terminal (T1) on said access network;
information (infoA) on a state of connectivity of at least one terminal (T1, T2, T3) to said access network (LAN2); and
information (infoA) on real-time performance parameters of said access network.

Correlatively, the invention is aimed at a terminal that can be connected to several access networks and characterized in that it includes:
a communication module configured to receive at least one packet called information packet, from a device for providing characteristic information of a said access network, the terminal being connected to this access network;
a processing module configured to obtain the characteristic information from the information packet; and
a connectivity management module configured to perform at least one action among:

maintaining a connection to at least one access network to which the terminal is already connected;

connecting the terminal to at least another said access network of different technology,

said characteristic information (infoA, infoB) of a said access network including at least information among:
information (infoB) on parameters of a user account of said terminal (T1) on said access network;
information (infoA) on a state of connectivity of at least one terminal (T1, T2, T3) to said access network (LAN2); and
information (infoA) on real-time performance parameters of said access network.

The characteristics and advantages of the selection method according to the invention presented below apply in the same way to the terminal according to the invention, and vice versa.

The terminal is initially connected to at least one access network from which it receives the information packet. If the terminal is initially connected to a single access network, based on the characteristic information:

either the terminal remains connected to this single access network;

or the terminal disconnects from this network and connects to another access network;

or the terminal remains connected to the first network and also connects to a second network.

The invention thus allows the terminal to optimize the selection and the access aggregation thanks to the characteristic information obtained from the information packet. The quality of experience of the terminal user will then be improved.

Particularly, the terminal can adapt the operation of software applications which are installed on this terminal based on the obtained characteristic information, for example when an obtained characteristic information concerns the bandwidth allocated by the access network to the terminal, the terminal can choose a video encoder and/or an audio encoder to be used by an application, the encoder being compatible with this bandwidth.

According to the invention, the terminal can be a mobile telephone of the Smartphone type, a computer, a tablet or any other communicating device configured to be able to be connected alternately or simultaneously to two access networks or more.

Network subscription information is part of the characteristics of an access network. The parameters of a user account can include a parameter derived from a database of SPR (Subscription Profile Repository) type for the access and charging control, or a reference date for an update of accounting of the traffic emitted and/or received by the terminal. The invention therefore allows avoiding a selection of an access network to which the user does not wish to connect for financial reasons.

Obtaining, by the terminal implementing the method of the invention, called first terminal, the state of connectivity of another terminal to the access network, allows the first terminal to deduce any interference between the two terminals and thus adapt the selection of an access network and the access aggregation to avoid or reduce the impact of these interferences.

Also, the terminal implementing the selection method in accordance with the invention can obtain information on its own connectivity to the access network, for example a CSI (Channel State Indicator) type indicator on the channel with which it is connected to this network, information on the rate consumed by the terminal, a percentage of the rate consumed by the terminal compared to an overall rate consumed on a LAN interface shared between several terminals connected to the access network, a percentage of the rate consumed by the terminal compared to an overall rate consumed on a connection interface of the access network to a WAN network, etc.

The information on the real-time performance parameters of the access network may include information on the connection rate offered by the access network (for the downlink direction and/or the uplink direction, rate per predefined time window), the total number of terminals connected to this network, the number of terminals connected and active on the access network (active in the sense that they are sending and/or receiving packets), the characteristics of connection of this access network to a WAN core network or to a metropolitan area network MAN, the synchronization rate of the access network, the latency in processing or conveying a packet via this network, etc. These performance parameters of the access network are dynamic parameters relating to a state of the access network in real time that is to say at the time of emission of the packet.

Thereby, the invention allows the terminal to obtain information of different kinds, allowing it to optimize its selection and its access aggregation.

Unlike the solutions of the prior art, the characteristic information obtained by the terminal is not estimated or calculated by the terminal itself, but is obtained from the information packet received from the device providing this information. The invention therefore allows providing the terminal with more complete and accurate information.

The invention is also aimed at a method for providing characteristic information of an access network, the method being implemented by a device of a network including the access network, the method comprising steps of:
inserting characteristic information in a field of a packet called information packet; and
sending the information packet to a terminal connected to the access network, the characteristic information including at least one information among:
information representative of real-time performance parameters of the access network;
information representative of a number of terminals connected to the access network;
information representative of a user account of the terminal on the access network;
information representative of a connectivity of the access network to a network WAN; and
information representative of a state of a traffic emission queue at the characteristic information providing device.

Correlatively, the invention is aimed at a device for providing characteristic information of an access network, this device being comprised in a network including the access network and comprising:
insertion means configured to insert the characteristic information in a field of a packet called information packet; and
communication means configured to send the information packet to a terminal connected to the access network,
   the characteristic information including at least one information among:
information representative of real-time performance parameters of the access network;
information representative of a number of terminals connected to the access network;
information representative of a user account of the terminal on the access network;
information representative of a connectivity of the access network to a WAN network; and
information representative of a state of a traffic emission queue at the device in accordance with the invention.

The characteristics and advantages of the selection method according to the invention apply in the same way to the characteristic information providing method according to the invention and vice versa. The characteristics and advantages of the characteristic information providing method according to the invention presented below apply in the same way to the device according to the invention, and vice versa.

The invention has an advantageous application in the case where a group of several terminals, including the terminal in accordance with the invention, share the same charging account, for example terminals corresponding to the same user account, or terminals of several users (members of a family) subscribed to the same package. The invention allows the terminal in accordance with the invention, by obtaining information on parameters of its user account, to obtain information on its consumption and on the consumption of its group of terminals, and therefore to optimize the selection of an access network and/or the access aggregation. It is noted that the solutions of the prior art do not allow a terminal to obtain information on the consumption of the other terminals of its group.

In one embodiment of the invention, the selection method implemented by the terminal (the method and the terminal being in accordance with the invention) further includes steps of:
inserting, in a field of a packet called query packet, a type of requested characteristic information;
sending the query packet to said characteristic information providing device, the information packet being received in response to the query packet.

In one embodiment of the invention:
the processing module of the terminal in accordance with the invention is further configured to insert, in a field of a packet called query packet, a type of requested characteristic information; and
the terminal communication module is further configured to send this query packet to the characteristic information providing device, the information packet being received in response to the query packet.

Thus, the invention allows the terminal to choose the information it needs, and to obtain only this information. The size of the information packet and the processing time thereof by the providing device and by the terminal are then optimized depending on the need.

In one embodiment of the invention, the characteristic information providing method in accordance with the invention is implemented following a receipt, by the device in accordance with the invention, of a packet called query packet including a request for the characteristic information. This mode allows the device in accordance with the invention to send information packets only when it is requested.

In other modes, described below, the device in accordance with the invention provides the information to the terminal automatically, without an explicit request from the terminal.

In one embodiment, the providing method in accordance with the invention is implemented following a change in an activity state of an interface of connection of the device in accordance with the invention to a network WAN, the device being comprised in the access network.

Indeed, when a WAN interface of the device in accordance with the invention is turned on or off, or when its synchronization parameters are modified, the parameters of connectivity of the access network to the WAN network change and the access network quality performances also change, the WAN interface allowing connecting the access network to the network WAN. This mode therefore allows notifying the terminal of these changes, so that it adapts its selection and its access aggregation.

In one embodiment, the providing method, in accordance with the invention, is implemented following an evolution of a bandwidth allocated by the access network to the terminal in accordance with the invention.

The bandwidth may evolve based on the traffic consumption by the terminal and/or based on an evolution in the account of the user of the terminal. Indeed, the bandwidth can be reduced or increased to meet a performance criterion of the network, such as the quality of service QoS, the packet transmission rate, or the latency, or to adapt the band to a financial criterion relating to the user account, for example when the user reaches a limit of a package to which he subscribed. In addition, the band allocated to the terminal may be modified due to a change in the user account at the user's initiative (termination or purchase of a package) or at the initiative of an operator of the network (modification of a package).

In one embodiment, the providing method in accordance with the invention is implemented following an evolution at a charging module for the account of the user of the terminal, for example when the terminal connects to an access network in a roaming condition, or when the terminal communicates with a platform of a paid service which is not comprised in a package associated with its user account.

In one embodiment, the providing method in accordance with the invention is implemented following an evolution of a network aggregation function to connect the device in accordance with the invention to a WAN network.

Indeed, a modification of the WAN network to which the access network is connected affects the performances of the access network and therefore the processing of the packets emitted/received by the terminal via this access network.

In one embodiment, the providing method, in accordance with the invention, is implemented following a detection of a change in the traffic volumetry to be handled by the device in accordance with the invention.

Indeed, this volumetry affects the ability of the device to process the information packets and the query packets. In addition, when the device in accordance with the invention is comprised in the access network, this volumetry affects the performances of the access network.

In one embodiment, the providing method, in accordance with the invention, is implemented following a connection or a renewal of connection of a terminal on a connection interface LAN of the device in accordance with the invention, the device being comprised in the access network. Indeed, the number of terminals connected to the device on its access network interface affects the performances of this network, as well as that of the device.

In one embodiment, the providing method, in accordance with the invention, is implemented following a change in a number of NAPT (Network Address Port Translation) type entries at the device in accordance with the invention. It is recalled that the number of NAPT-type entries may evolve following a change in the number of connected terminals, or following a change in a connectivity characteristic of an already connected terminal, such as the connection rate. This mode can in particular be implemented when the device in accordance with the invention supports the IPv4 protocol.

In one embodiment, the providing method in accordance with the invention is implemented following a receipt by the device in accordance with the invention of a Router Solicitation (RS) type message. This mode can be implemented when the device in accordance with the invention is a router which supports the IPv6 protocol. It is recalled that a RS-type message is emitted by a terminal to ask a router to announce its presence.

In one embodiment, the providing method in accordance with the invention is implemented following an emission by the device in accordance with the invention of a Router Advertisement (RA) type message. This embodiment can be implemented when the device in accordance with the invention is a router which supports the IPv6 protocol. It is recalled that an RA-type message is emitted by a router periodically or in response to an RS-type message, to announce its presence.

In one embodiment, the providing method in accordance with the invention is implemented following a detection of a Neighbor Discovery (ND) or Neighbor Solicitation (NS) type message. This mode can be implemented when the device in accordance with the invention is a router which supports the IPv6 protocol. It is recalled that the ND and NS type messages are used by a router to communicate with other neighboring routers.

In one embodiment, the providing method in accordance with the invention is implemented following an elapse of a determined period of time since the last time an information packet has been sent. This embodiment allows the device in accordance with the invention to send information packets to the terminal in accordance with the invention, periodically or at predefined times.

In one embodiment, the information packet and/or the query packet conform to a protocol for supervising the Internet protocol, for example the ICMP (Internet Control Message Protocol) protocol.

It is recalled that the ICMP protocol is an integral part of the TCP/IP software stacks. This ICMP protocol, of the 3^{rd} layer of the OSI model, allows the routers to send error or supervision messages to other routers or computers. The ICMP packets are encapsulated in IP datagrams and they are used with IP packets. Indeed, as the IP protocol (in its two IPv4 and IPv6 versions) only manages the transport of the packets, the ICMP packets are used in accompaniment to the IP packets for the sending of error or supervision messages.

Thus, the invention is compatible with the ICMP, IPv4 and IPv6 protocols, and can therefore be easily implemented by terminals and devices currently available on the market with minor modifications to insert, retrieve and process the characteristic information of the access networks.

Also, the invention is compatible with the MPTCP aggregation protocol.

Also, the invention can be applied regardless of the technology of the access network: WiFi, cellular, Ethernet, satellite, cable, xDSL, fiber, etc.

Also, the invention can be compatible with the combinatorial tunnel mechanisms, allowing switching from one protocol among the IPv4, IPv6 and GTP (GPRS Tunneling Protocol) protocols to another.

The invention is also compatible with the security mechanisms of the state of the art, such as the IPSec (Internet Protocol Security), sRTP (Secured Real Time Protocol), SIPS (Session Initiation Protocol Secured), HTTPS (Hyper Text Transfer Protocol Secured), and TLS (Transport Layer Security) protocols.

In accordance with the prior art, an IP datagram that encapsulates an ICMP packet includes an IP header and the ICMP packet. The ICMP packet includes:
a field “ICMP message type” which encodes the nature of the ICMP packet, for example the type “3” indicates an unreachable destination;
a field “code of the error” including information complementary to the type field and specifies the cause of the sending of the ICMP packet, for example as a complement to the type 3, the code 2 indicates inaccessible protocol, and the code 3 indicates inaccessible port;
a checksum field calculated on the part specific to ICMP without the IP header allowing verifying the integrity of the packet; and
an optional data field.

In the current state of the art, there are two versions of ICMP packets: the ICMP v4 packets (IETF RFC 792 specification) which accompany IPv4 packets, and ICMP v6 packets (IETF RFC 4443 specification) which accompany IPv6 packets. In the case of an ICMP v4 packet encapsulated in an IP datagram, the field “protocol” of the IPv4 header includes the code “1” to indicate that this IP datagram encapsulates an ICMP packet. In the case of an encapsulated ICMP v6 packet, the field “next header” of the IPv6 header includes the code “58” to indicate that the IP datagram encapsulates an ICMP packet.

In the embodiment of the invention where the information packet conforms to the ICMP protocol, the type field may include information to specify that it is an information packet. The code field may include information to indicate the reason for sending this information packet, or the type of the characteristic information provided in this information packet. The data field may include the characteristic information of the access network.

In the embodiment where the query packet conforms to the ICMP protocol, the type field may include information to specify that it is a query packet. The data field can include the type of the characteristic information requested by the terminal. Alternatively, the type field can include information that specifies that it is both a query packet and the type of the requested information.

It is noted that the field “type” of an ICMP packet consists of 8 bits, therefore it allows supporting 256 possible values. Considering the values currently used by methods of the state of the art, there is still room to use this field for the methods of the present invention. The field “data” of an ICMP packet is optional and of variable length.

In another mode alternative to the use of the ICMP protocol, the information and query packets can be exchanged between the terminal and the device, in accordance with the invention, according to a new proprietary protocol. This protocol can rely, for example, on the TCP, UDP (User Datagram Protocol) or SCTP (Stream Control Transport Protocol) transport protocols. However, a software application that listens on a TCP, UDP or SCTP port is required at the terminal and at the device.

Alternatively, the characteristic information can be sent by the device to the terminal in accordance with the invention, by using a notification mechanism, for example the APNS (Apple Push Notification Server) mechanism proposed by Apple or the FCM (Firebase Cloud Messaging) mechanism proposed by Google (registered trademarks). In this case, a notification platform is necessary.

The information providing device in accordance with the invention may include:
network termination equipment, such equipment is marketed in France under the name “box” offering multiple services, such as a LiveBox equipment (product marketed by Orange);
an access point for a cellular access network, such as an eNodeB-type antenna; or
a router.

The invention is also aimed at a system for providing characteristic information of an access network. This system includes at least one terminal in accordance with the invention and at least one information providing device in accordance with the invention.

The invention is also aimed at a first computer program on a recording medium, this program being likely to be implemented in a computer or a terminal in accordance with the invention. This program includes instructions adapted to the implementation of a selection method as described above.

The invention is also aimed at a second computer program on a recording medium, this program being likely to be implemented in a computer or an information providing device in accordance with the invention. This program includes instructions adapted to the implementation of an information providing method as described above.

Each of these programs can use any programming language, and be in the form of source code, object code, or intermediate code between source code and object code, such as in a partially compiled form, or in any other desirable form.

The invention is also aimed at an information medium or a recording medium readable by a computer, and including instructions of the first or of the second computer program as mentioned above.

The information or recording media can be any entity or device capable of storing the programs. For example, the media can include a storage means, such as a ROM, for example a CD ROM or a microelectronic circuit ROM, or a magnetic recording means, for example a floppy disk or a hard disk, or a flash memory.

On the other hand, the information or recording media can be transmissible media such as an electrical or optical signal, which can be conveyed via an electrical or optical cable, by radio link, by optical wireless link or by other means.

The programs according to the invention can be particularly downloaded from an Internet-type network.

Alternatively, each information or recording medium can be an integrated circuit in which a program is incorporated, the circuit being adapted to execute or to be used in the execution of the response method in accordance with the invention or of the method for providing a response element in accordance with the invention.

### BRIEF DESCRIPTION OF THE DRAWINGS

Other characteristics and advantages of the present invention will emerge from the description given below, with reference to the appended drawings which illustrate an exemplary embodiment thereof without any limitation. In the figures:

FIG. 1, already described, illustrates an architecture of a network of the prior art supporting the MPTCP protocol;

FIG. 2, already described, illustrates a software architecture of a terminal of the prior art, which can simultaneously connect to several access networks;

FIG. 3 illustrates an architecture of a network in which the methods of the invention are implemented according to a first embodiment of the invention;

FIG. 4 is a flowchart representing steps of the methods of the invention, implemented according to the first embodiment;

FIG. 5 illustrates an architecture of a network in which the methods of the invention are implemented according to a second embodiment of the invention;

FIG. 6 presents functional architectures of a management system, of a terminal and of a management device, in accordance with the invention;

FIG. 7 presents a hardware architecture of a terminal in accordance with the invention, according to one embodiment of the invention; and

FIG. 8 presents a hardware architecture of a device in accordance with the invention, according to one embodiment of the invention.

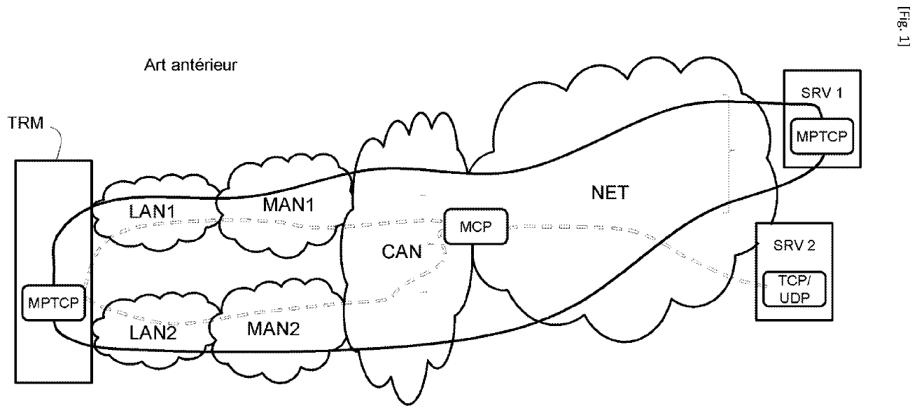

### DESCRIPTION OF THE EMBODIMENTS

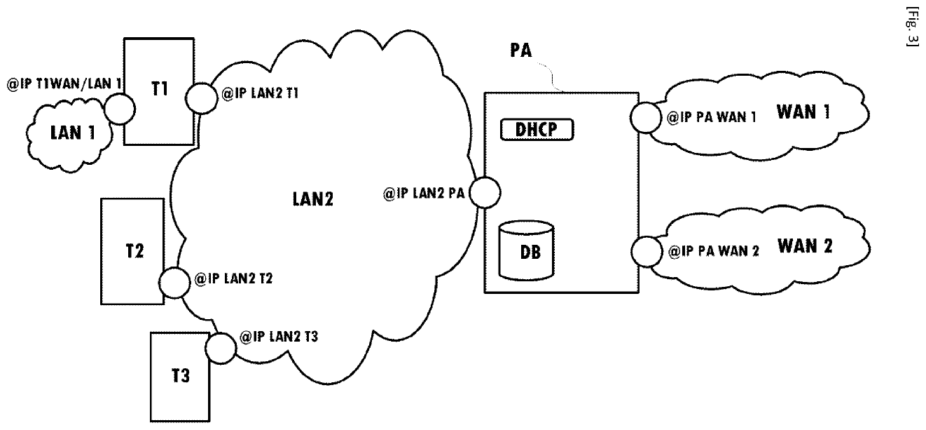

FIG. 3 illustrates an architecture of a network in which the methods of the invention are implemented according to a first embodiment of the invention.

The network in FIG. 3 includes an access point PA that interfaces between an access network LAN2 on the one hand, and two core networks WAN1 and WAN2 on the other. In this example, the access point PA is a network termination equipment, commercially known in France by the name “box”. It has a LAN connection interface allowing it to connect to the network LAN2, and two WAN connection interfaces allowing it to connect to the networks WAN1 and WAN2.

This access point PA constitutes an information providing device in accordance with the invention.

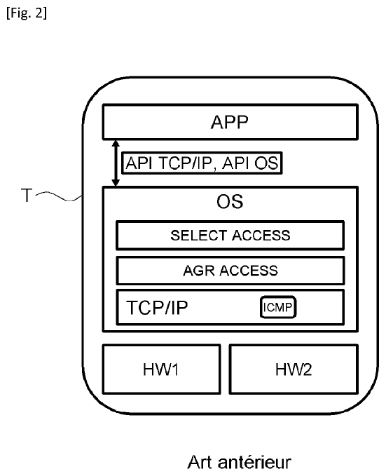

Three terminals T1, T2 and T3 are connected to the device PA via the access network LAN2. The terminal T1, in accordance with the invention, can be connected simultaneously to the access network LAN2 and to another access network LAN1. The software architecture of the terminal T1 is of the type of the architecture illustrated by FIG. 2, but its TCP/IP protocol stack is modified to support new types of an ICMP packet in accordance with the invention. These new types will be described by the following with reference to FIG. 4. The terminal T1 includes a selection module configured to select an access network among the access networks to which the terminal T1 can connect. The terminal T1 also includes an aggregation module configured to aggregate the traffic emitted and/or received by the terminal T1 between at least two access networks to which the terminal T1 can be connected simultaneously.

The terminal T2 can connect to only one access network at a time. The TCP/IP protocol stack of the terminal T2 is modified like that of the terminal T1. The terminal T3 is a terminal of the prior art, this terminal T3 has a TCP/IP stack of the state of the art.

In this example, the connection interface of the device PA with the network WAN1 is wired, of ADSL technology. The connection interface of the device PA with the network WAN2 is of the cellular radio type. The device PA is configured to prefer a connection to the network WAN1 over a connection to the network WAN2: it connects to the cellular network WAN2 only when its connection with the wired network WAN1 is lost or in case of a degraded quality below of a determined threshold. The device PA has a TCP/IP protocol stack of the prior art at its two interfaces WAN.

In this example, the terminal T1 is a Smartphone-type telephone, the network LAN1 is a cellular access network, and the network LAN2 is a WiFi access network, which is therefore of different technology than the cellular access network. The interface LAN of the device PA has a TCP/IP protocol stack which integrates an ICMP module, and which is modified relative to a stack of the prior art to support the new types of an ICMP packet in accordance with the invention, and which are described below, with reference to FIG. 4.

The device PA includes a DHCP (Dynamic Host Configuration Protocol) server which assigns IP addresses to the terminals T1, T2 and T3 on the access network LAN2. The terminal T1 also has an IP address on the network LAN1 which has been assigned thereto by a PGW (Packet data network GateWay) server of the cellular network.

The device PA also includes an internal database DB which stores information useful for the operation of the device PA as a gateway, such as an IP address assigned to the device PA by a DHCP server (not presented in the figure) of the network WAN1, an IP address assigned to the device PA by a server PGW (not presented in the figure) of the network WAN2, and NAPT-type tables which evolve based on the traffic of the terminals T1, T2 and T3.

The NAPT-type tables include correspondences obtained from an IP packet or from an IP packet session: an IP address of a terminal, a source port number of the terminal, a destination port number, an IP address of a destination server, an identifier of a transport protocol (such as TCP, UDP or SCTP), an IP address and a source port of the used WAN interface of the device PA.

The device PA manages different traffic queues through each of its interfaces LAN and WAN.

A web browser application is installed on the terminals T1 and T3. A voice or video over IP application is installed on the terminal T2.

FIG. 4 is a flowchart representing steps of a selection method implemented by the terminal T1, steps of an information providing method implemented by the device PA, and preliminary steps to these two methods, the terminal T1, the device PA and the two methods being in accordance with the invention.

Particularly, steps E405, E406, E412, E413, E420, E421, E440, E442 described later are steps of the selection method in accordance with the invention.

Steps E409, E410, E416, E418, E428, E430, E436, E438 described later are steps of the information providing method, in accordance with the invention.

The flowchart of FIG. 4 is applied in the network architecture described with reference to FIG. 3. However, it is assumed that initially the device PA is not active and that none of the terminals T1, T2 and T3 is connected to this device PA and that none of these terminals has an IP address on the network LAN2.

During a step E400, the device PA is turned on. Depending on its configuration, it connects to the network WAN1. To do so, it exchanges synchronization information with access equipment for the network WAN1, such as an equipment of DSLAM type in ADSL technology with, for example, an asymmetric synchronization profile of 2 Mbit/s in the downlink direction and 500 kbit/s in the uplink direction.

During a set of steps E402, the device PA and particularly its internal client DHCP establishes a session with a DHCP server of the network WAN1. The server DHCP of the network WAN1 assigns an IP address to the device PA on the network WAN1. The device PA records this IP address as well as the synchronization characteristics in its database DB.

Depending on the configuration of the device PA, since the preferred connection interface WAN1 is active, the interface of connection to the network WAN2 is deactivated.

During a step E404, the terminal T1 connects to the device PA and is assigned an IP address on the network LAN2 as described above, by the server DHCP of the device PA.

During a step E405 of the selection method in accordance with the invention, the terminal T1 inserts in a “type” field of a packet PQ called ICMP type query packet the value “250”, and in a “data” field of this query packet PQ a type of requested characteristic information.

During a step E406, the terminal T1 sends the query packet PQ to the device PA.

During a step E408 of the information providing method in accordance with the invention, the device PA receives the query packet PQ, it deduces from the value “250” of the “type” field that this packet PQ includes an information request, and it extracts the type of information requested from the field “data”. Then, the device PA consults its database DB to obtain the requested information infoA.

During a step E409, the device PA inserts a value “251” in a field “type” of a packet PR called information packet PR, of ICMP type, and inserts the requested information infoA, characteristic of the access network LAN2, in a field “data” of the information packet PR.

During a step E410, the device PA sends the information packet PR to the terminal T1 connected to the access network LAN2.

It is noted that if the access point does not implement the providing method in accordance with the invention, it cannot interpret the value “250” of the field “type”. As a result, the access point PA ignores the query packet PQ because the ICMP protocol indicates that an ICMP packet should not be answered with an ICMP packet in case of error. As the terminal T1 does not receive a response, it will conclude that the access point PA does not implement the method of the invention.

In the mode described here, the type of requested information, inserted by the terminal T1 in the packet data PQ field, is “all” asking the device PA to provide it with all the information infoA it has on the access network LAN2 and on the networks WAN to which the device PA can connect the access network LAN2.

In this example, the information infoA contained in the field “data” of the information packet PR is as follows:

Type of access network WAN1=ADSL

State=ON

IPv4 address WAN1

Lease time of the IP address WAN1

emission direction WAN1 synchronization rate=500 kbit/s

receipt direction WAN1 synchronization rate=2 Mbit/s

Number of NATP entry/entries created for the interface WAN1=0

Number of queue(s) in emission=1

Maximum emission queue size 1 Mega octets

Average emission rate=0.01 kbit/s

Average receipt rate=0.01 kbit/s

Type of access network WAN2=4G

State=OFF

Number of total IP addresses distributed on the LAN=1

Interface used by this terminal: Interface 1 LAN

Type Interface 1 LAN:WiFi a/c 2.4 GHz

Number of terminals on Interface 1 LAN=1

Emission on interface 1 LAN average rate=0.005 kbit/s

Receipt on interface 1 LAN average rate=0.005 kbit/s

During a step E412, the terminal T1 receives the information packet PR. It deduces by the value “251” in the field “type” of this packet PR that it is an information packet within the meaning of the invention, and extracts the characteristic information infoA from the field “data” of the packet PR. Thus, the TCP/IP protocol stack of the terminal T1 reports this information infoA to the selection and access aggregation modules of the terminal T1.

After analyzing the information infoA, the selection module considers that the access rate for the network LAN2 is sufficient in the downlink direction (2 Mbit/s) and selects the access network LAN2 (despite the access network LAN1). The aggregation module also considers that the connection to the network LAN2 is sufficient and does not activate the access aggregation.

In one embodiment, the terminal T1 requests information from the device DA periodically. Thus, steps E405 to E412 are implemented periodically.

In this example, during a set of steps E414, similar to steps E404, the terminal T2 connects to the network LAN2 and is assigned an address IP on this network LAN2 by the internal server DHCP of the device PA.

Following the change in the number of terminals connected to the access network LAN2, the device PA inserts during a step E416 similar to step E409, new information infoA2 in an information packet PR2, and sends on its own initiative, during a step E418 similar to step E410, the information packet PR2 to the terminal T1. The information infoA2 differs from the previous information infoA in that the item “number of IP addresses assigned on the LAN” is equal to 2. Based on the traffic emitted and/or received by the terminal T1, the items “emission on interface LAN average rate” and “receipt on interface LAN average rate” may also be different.

During a step E420, the terminal T1 receives this packet PR2 and decides based on the new obtained information infoA2, to maintain its access mode: the selection of the access network LAN2 and the deactivation of the access aggregation.

During steps E422 and E424, similar to steps E405 and E406, the terminal T2 inserts a value “250” in a field “type” and the type of requested information in a field “data” of a query packet PQ3 and sends this packet PQ3 to the device PA. It is assumed that the terminal T2 requests the same type of information as those requested by the terminal T1.

During a step E426, the device PA receives this packet PQ3, inserts during a step E428 (similar to step E409) a value “251” in the field “type” of an information packet PR3 and the information infoA2 in the field “data” of the packet PR3, and sends during a step E430 (similar to step E410) the information packet PR3 to the terminal T2.

The terminal T2 receives this information infoA2 during a step E432, and uses them to select a video codec, for its video over IP application, adapted for the connection to the network WAN1 and to the traffic of the other terminals connected on the access network LAN2.

Having information on the possible rate of the device PA and on the use of the terminal T1 on the network LAN2, the videophone application of the terminal T2 requests during a step E434 the establishment of a videophone session with a codec requiring for example, on average 450 kbt/s, so as not to exceed the uplink synchronization rate of the ADSL access of the device PA and to take into account the moderate uplink traffic of the terminal T1.

The establishment of this videophone session by the terminal T2 results in the creation, at the device PA of new entries in its NAPT-type table: an entry for the call signaling, an entry for the audio RTP (Real-Time Transport Protocol) stream, and an entry for the video RTP stream). Following this change (E434) of NAPT entries, the device PA generates and sends, during steps E436 and E438 similar to steps E416 and E418, a new information packet PR4, it sends on its own initiative to the terminal T1.

Receiving the information packet PR4 during a step E440, the terminal T1 can modify its selection of the access network by switching all its traffic on the cellular access network LAN1, or activate the aggregation by keeping part of its traffic on the network LAN2 and by switching the other part on the network LAN1.

Assuming that during a later step, the terminal T3 connects to the access network LAN2. When the device PA detects a change in the number of NAPT-type entries (because of the end of the videophone session of the terminal T2 for example) and sends information packets on its own initiative to all the connected terminals T1, T2 and T3, the terminal T3 of the prior art cannot interpret the information packet and will therefore ignore it. The implementation of the methods of the invention does not affect the operation of the terminal T3 of the prior art.

In another embodiment, the device PA inserts a DHCP option when it assigns an IP address to a terminal to inform it that this device PA implements the information providing method in accordance with the invention.

In another embodiment, the terminal T1 inserts in a DHCP request DISCOVER sent to connect to the access point PA, a DHCP option to inform the device PA that this terminal T1 implements the selection method in accordance with the invention.

In one embodiment, the device PA connects to the core network WAN2, due to a loss of connection to the network WAN1 or due to a degradation of the connection to the network WAN1 below a determined connection quality threshold. In this case, the device PA generates information packets in accordance with the invention, and sends them on its own initiative to all the terminals of the access network LAN2 to which it is connected. The sending of these packets can be in point-to-point mode, in multipoint mode or in broadcast mode.

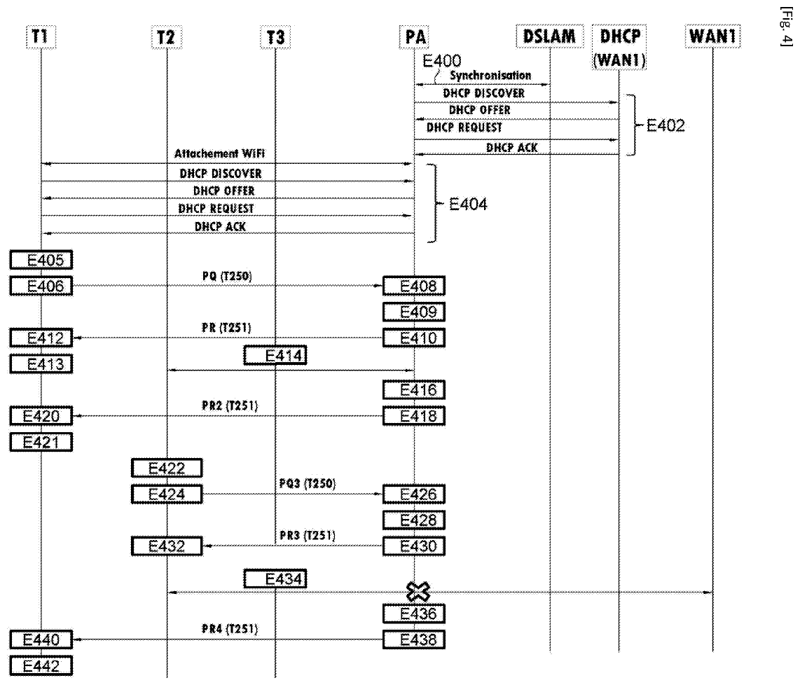

FIG. 5 illustrates an architecture of a network in which the methods of the invention are implemented according to one embodiment of the invention.

The terminal T1, in accordance with the invention, is attached to a 4^{th} generation (4G) cellular network. It is connected via the access network LAN1 to an antenna eNodeB. This antenna eNodeB constitutes a gateway between the access network LAN1 and a core network NET4G.

The following steps describe what takes place at the cellular network, in accordance with the state of the art, when the terminal T1 connects to the access network LAN1.

The terminal T1 exchanges signaling data with an MME (Mobility Management Entity) entity. The MME entity communicates, in accordance with the state of the art, with an HSS (Home Subscriber Server) server to identify and authenticate the user of the terminal T1. Then, an IP-CAN (Internet Protocol-Connectivity Access Network) session is established.

During the establishment of the IP-CAN session, a router PGW (Packet data network Gateway) allocates an IP address to the terminal T1 so that it can use the Internet service and an IP tunnel is established between T1 and the antenna eNodeB, then between the antenna eNodeB and an anchor router SGW (Serving GateWay) for the terminal T1, then between the router SGW and the router PGW allowing access to the Internet service.

Once the terminal T1 has the IP address for the access to the Internet service, it can exchange traffic in bidirectional mode. To account this exchanged traffic, the router PGW has a PCEF (Policy and Charging Enforcement Function) function which communicates with a PCRF (Policy Charging Rules Function) entity. The PCRF obtains from an SPR (Subscription Profile Repository) database the type of subscription of the user of the terminal T1, for example 5 Giga-bytes per month. This SPR database is supplied by an application of the Information System (IS) of the mobile operator.

The router PGW is also interconnected with real-time OCS (Online Charging System) or non-real time OFCS (Offline Charging System) charging systems.

The router PGW also integrates a DPI (Deep Packet Inspection) function which allows identifying particular and predetermined streams on the basis of rules passed by the PCRF entity via the PCEF module to account or not these streams.

The steps described above are in accordance with the state of the art, and they are described here to present the context of implementation of the invention.

Indeed, the router PGW constitutes a device for providing information infoB characteristic of the access network LAN1, this device PGW being in accordance with the invention. The device PGW in accordance with the invention has particularly information infoB, relating to the account of the user of the terminal T1. It inserts in a field “type” of an ICMP-type packet PR, a value “253” to indicate that this packet PR is an information packet in accordance with the invention. It also inserts the characteristic information infoB in a field “data” of the information packet PR and sends this packet PR to the terminal T1.

When the terminal T1 receives this packet PR, it extracts the information infoB from this packet PR and reports the information PR to its selection and access aggregation modules. Based on the information infoB, the terminal T1 can maintain its connection to the access network LAN1 only, or disconnect from the network LAN1 and connect to another access network LAN2, or maintain its connection to the network LAN1 and also connect to the network LAN2 in access aggregation mode.

The device PGW in accordance with the invention can implement the information providing method, in accordance with the invention:

following the receipt of a query packet PQ from the terminal T1;

at each reset of a counter of the traffic volumetry consumed by the terminal T1 or by a set of terminals sharing the same subscription and comprising the terminal T1, the reset information being obtained by the device PGW from of the server PCRF;

following a change of the user's subscription;

following an exceeding of the traffic volumetry consumed by the terminal T1, by a determined threshold;

at each establishment of an IP-CAN session concerning the terminal T1;

at each change of a characteristic on the performances of the access network LAN1, for example a change of maximum possible rate, in case of mobility from the 4^{th} to the 3^{rd} generation (4G/3G) or vice versa; and/or

following an elapse of a determined period of time since the last time an information packet PR has been sent, in this case the providing method can be implemented periodically or at predetermined times.

In the case where the device PGW implements the information providing method following an exceeding of the traffic volumetry consumed by the terminal T1 by a determined threshold, this threshold may correspond to a package to which the user subscribed, for example 10 Giga bytes. Alternatively, this threshold can correspond to a consumption level, the threshold can be initialized at a determined value and it can be updated (incremented for example) each time the consumption level is reached, for example every 1 Giga bytes consumed, counted from the initialization or from the last update of the threshold.

The antenna eNodeB transmits the information packet PR sent by the device PGW to the terminal T1.

In one embodiment, the antenna eNodeB inserts into the field “data” of the packet PR, before transferring the packet PR to the terminal T1, information infoA relating to the connection quality of the network LAN1.

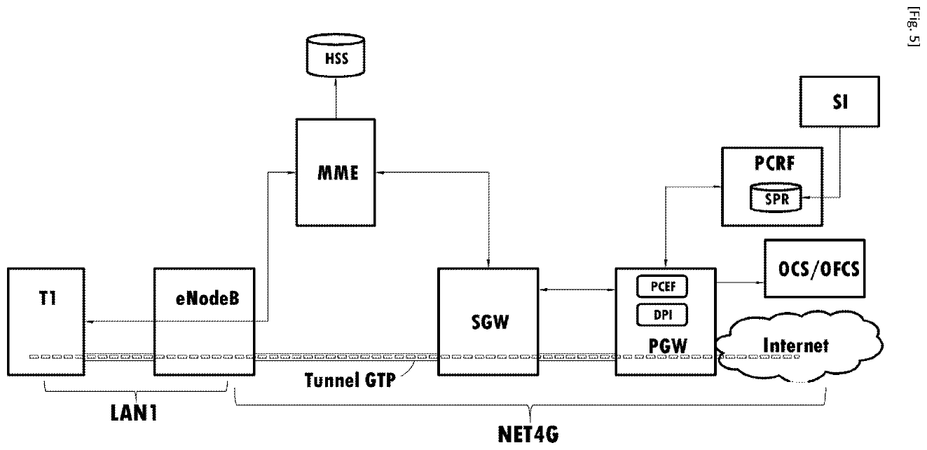

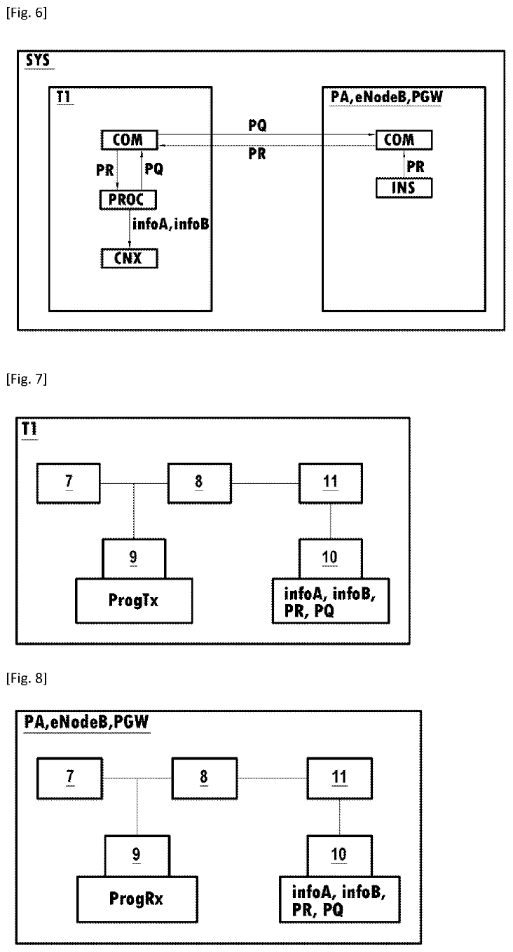

FIG. 6 represents functional architectures, according to one embodiment of the invention, of a characteristic information providing system SYS, of a terminal T1 and of a providing device PA (or eNodeB or PGW), the system SYS, the terminal T1 and the device PA all being in accordance with the invention.

The system SYS includes the terminal T1 and the device PA, eNodeB or PGW.

The terminal T1 includes:
a communication module COM configured to receive at least one information packet PR, from the device PA (eNodeB, PGW) for providing characteristic information infoA, infoB of the access network LAN2 (LAN1), the terminal T1 being connected to this access network;
a processing module PROC configured to obtain said characteristic information infoA, infoB from the information packet PR; and
a connectivity management module CNX configured to perform at least one action among:

maintaining a connection to at least one access network to which the terminal T1 is already connected;

connecting the terminal T1 to at least another access network.

In one embodiment:
the processing module PROC is further configured to insert, in a field of a query packet PQ, a type of requested characteristic information;
the communication module COM is further configured to send the query packet PQ to said device in accordance with the invention.

The Device PA (eNodeB, PGW) for providing characteristic information infoA (infoB) of an access network LAN2 (LAN1), is comprised in a network LAN2, (NET4G) including the access network. The device in accordance with the invention includes:
insertion means INS configured to insert the characteristic information in a field of the information packet PR; and
communication means COM configured to send the information packet PR to the terminal T1.

In the embodiment described here, the terminal T1 has the hardware architecture of a computer, as illustrated in FIG. 8.

The architecture of the terminal T1 comprises in particular a processor 7, a random access memory 8, a read only memory 9, a non-volatile flash memory 10 in a particular embodiment of the invention, as well as communication means 11. Such means are known per se and are not described in more detail here.

The read only memory 9 of the terminal T1 according to the invention constitutes a recording medium in accordance with the invention, readable by the processor 7 and on which a computer program ProgTx in accordance with the invention is here recorded.

The memory 10 of the terminal T1 allows recording the variables used for executing the steps of the selection method according to the invention, such as the information infoA and infoB, and the information PR and query PQ packets.

The computer program ProgTx defines functional and software modules here, configured to select an access network. These functional modules rely on and/or control the hardware elements 7-11 of the terminal T1 mentioned above.

In the embodiment described here, the information providing device, PA, eNodeB or PGW, has the hardware architecture of a computer, as illustrated in FIG. 9.

The architecture of the device PA, eNodeB or PGW comprises in particular a processor 7, a random access memory 8, a read only memory 9, a non-volatile flash memory 10 in a particular embodiment of the invention, as well as communication means 11. Such means are known per se and are not described in more detail here.

The read only memory 9 of the device PA, eNodeB or PGW according to the invention constitutes a recording medium in accordance with the invention, readable by the processor 7 and on which a computer program ProgRx in accordance with the invention is here recorded.

The memory 10 of the device PA, eNodeB or PGW allows recording variables used for executing the steps of the information providing method according to the invention, such as the information infoA and infoB, and the information PR and query PQ packets.

The computer program ProgRx defines functional and software modules here, configured to provide characteristic information of an access network. These functional modules rely on and/or control the hardware elements 7-11 of the device PA, eNodeB or PGW mentioned above.

1. A method for selecting at least one access network, the method implemented by a terminal configured to be connected to several access networks the method comprising steps of:
receiving at least one information packet (PR), from a device for providing characteristic information of an access network, terminal being connected to the access network; and
based on the characteristic information obtained from the information packet, at least one step among:
maintaining a connection to at least one access network to which the terminal is already connected; and
connecting to at least another access network of different technology,
the characteristic information of an access network including at least information among:
information on parameters of a user account of the terminal on the access network;
information on a state of connectivity of at least one terminal to the access network; and
information on real-time performance parameters the said access network.

2. The method of claim 1, further comprising:
inserting, in a field of a query packet, a type of requested characteristic information;
sending the query packet to the device, the information packet being received in response to the query packet.

3. A method for providing characteristic information of an access network, the method implemented by a device of a network including said access network, the method comprising:
inserting the characteristic information in a field of an information packet; and
sending the information packet to a terminal connected to the access network,
the characteristic information including at least one information among:
information representative of real-time performance parameters of the access network;
information representative of a number of terminals connected to the access network;
information representative of a user account of the terminal on the access network;
information representative of a connectivity of the access network to a network WAN; and
information representative of the state of a traffic emission queue at the device.

4. The method of claim 3, wherein the method is implemented following at least one event among:
a receipt by the device of a query packet including a request for the characteristic information;
a change in an activity state of an interface of connection of the device to a WAN network, the device being comprised in the access network;
an evolution of a bandwidth allocated by the access network to the terminal;
an evolution at a charging module for an account of the user of the terminal;
an evolution of a network aggregation function allowing connecting the device to a WAN network;
a detection of a change in the traffic volumetry to be handled by the device;
a connection or a renewal of connection of a terminal on a LAN connection interface of the device, the device being comprised in the access network;
a change in a number of NAPT-type entries at the device;
a receipt by the device of a Router Solicitation type message;
a detection of a Neighbor Discovery or Neighbor Solicitation type message; and
an elapse of a determined period of time since the last time an information packet has been sent.

5. The method claim 1 wherein the query packet and/or the information packet conform to the ICMP protocol.

6. A non-transitory computer readable medium having stored thereon instructions which, when executed by a processor, cause the processor to perform the method of claim 1.

7. A non-transitory computer readable medium having stored thereon instructions which, when executed by a processor, cause the processor to perform the method of claim 3.

8. A terminal configured to be connected to several access networks, the terminal comprising a processor, the terminal configured to:
receive at least one information packet, from a device for providing characteristic information of an access network, the terminal being connected to the access network;
obtain said characteristic information from said information packet; and
perform at least one action among:
maintaining a connection to at least one access network to which the terminal is already connected;
connecting the terminal to at least another access network of different technology,
the characteristic information of an access network including at least information among:
information on parameters of a user account of the terminal on the access network;
information on a state of connectivity of at least one terminal to the access network; and
information on real-time performance parameters of the access network.

9. The terminal claim 8, wherein the terminal is further configured to:
to insert, in a field of a query packet, a type of requested characteristic information; and
send the query packet to the device, the information packet being received in response to the query packet.

10. A device for providing characteristic information of an access network, the device being comprised in a network including the access network, the device comprising a processor, the device configured to:
insert the characteristic information in a field of an information packet; and
send the information packet to a terminal connected to the access network,
the characteristic information including at least one information among:
information representative of real-time performance parameters of the access network;
information representative of a number of terminals connected to the access network;
information representative of a user account of the terminal on the access network;
information representative of connectivity of the access network to a WAN network; and
information representative of the state of a traffic emission queue at the device.

11. The device of claim 10, including:
network termination equipment;
an access point for a cellular access network; or
a router.

12. A system for providing characteristic information of an access network including at least one terminal of claim 8 and device for providing characteristic information of an access network, the device being comprised in a network including the access network, the device comprising a processor, the device configured to:
insert the characteristic information in a field of an information packet; and
send the information packet to a terminal connected to the access network,
the characteristic information including at least one information among:
information representative of real-time performance parameters of the access network;
information representative of a number of terminals connected to the access network;
information representative of a user account of the terminal on the access network;
information representative of connectivity of the access network to a WAN network; and
information representative of the state of a traffic emission queue at the device.

13. The method of claim 3, wherein the query packed and/or the information packed conform to the ICMP protocol.
